(19) United States
(12) Patent Application Publication
(10) Pub. No.: US 2014/0290417 A1
(43) Pub. Date: Oct. 2, 2014

(54) METHOD AND APPARATUS FOR MOVING AND POSITIONING A GRIPPING UNIT, AND A ROBOT PROVIDED WITH GRIPPING UNIT

(71) Applicant: ZENROBOTICS OY, Helsinki (FI)

(72) Inventor: Tuomas Lukka, Helsinki (FI)

(21) Appl. No.: 14/117,409

(22) PCT Filed: May 8, 2012
(86) PCT No.: PCT/FI12/50440

§ 371 Date: Mar. 20, 2014

(30) Foreign Application Priority Data
May 13, 2011 (FI) 20115466

(51) Int. Cl. B25J 9/00

(52) U.S. Cl. CPC B25J 9/0078
USPC 74/490.04

(57) ABSTRACT

A method and apparatus for moving and positioning a gripping unit (3; 23; 43), in which method the gripping unit is moved and positioned by intermediation of cables (9, 10, 11, 12; 29, 30, 31; 48, 49, 50), so that at least one degree of freedom of the gripping unit is removed by fastening the gripping unit mechanically (4; 24; 44) to the support structure. A robot (1; 21; 41) provided with this kind of apparatus is also described.

The invention relates to moving and positioning a gripping unit of a robot. More precisely, the invention relates to moving and positioning a robot gripping unit by intermediation of cables.

The use of various robots in different industrial tasks is known from the prior art. Robots are used for example in various assembly tasks, generally in tasks that must be repeated very accurately, such as the production of circuit boards. In that case the robot is typically provided with a grip element that grips the component to be assembled, and places it precisely at the right spot of the product to be assembled. One important application for the use of robots is welding, where the robot performs, according to the logics programmed therein, welding operations rapidly and precisely, also in particularly difficult places. Packaging industry also uses various different robots, such as palletizing robots, for packing goods.

A robot developed for dealing with small and light-weight objects, especially in the packaging industry, is the Delta robot formed of three arms that are at their lower end attached to one and the same basic body or plane, so that said arms support the working surface. The operation of the Delta robot is based on parallelogram-based control, where the robot is controlled in four different degrees of freedom: in three translational (X, Y and Z) and in one rotational degree of freedom. Among the advantages of the Delta robot are fast acceleration, up to 30 g, and fairly high speed, up to 10 m/s.

One of the operational principles of robots provided with a manipulator is connected to controlling the manipulator by intermediation of cables. Examples of this type of robots are Robocrane-type robots. The manipulator of a Robocrane-type robot is controlled by six cables and cable-connected servo winches, so that the manipulator can be moved in all six different degrees of freedom: in three translational and three rotational degrees of freedom.

In this description, the term ‘servo winch’ refers to servo motors provided with suitable means for coiling cable, in the simplest case for instance a cable reel rotated by a servo motor.

Examples of other robots where a manipulator, such as a gripping unit, is controlled by intermediation of a cable, are unidirectionally controlled cable robots of the Fraunhofer institute, such as IPAnema, which is controlled by intermediation of eight cables.

Among the problems with these robots provided with a gripping unit controlled by several cables are for example vibrations of the gripping unit, cables coming from different directions make it difficult to define the robot working space, and the number of required servo winches and the controls needed for each cable increase the production expenses of the robot, in addition to which the necessary control logics and the affecting kinematics are complicated.

Even though regular industrial robots are already being used in many different industrial fields, they are not very well suited for tasks where the robot or its manipulator, such as a gripping unit, are for instance subjected to impacts and required to work with a continuously changing target.

One of these kinds of industrial fields is waste sorting, where waste material is fed continuously to be sorted for example on a conveyor belt. In that case the sorted objects are different in shape, and the form of the material stream is continuously changing. In this type of sorting work, also rapid work movements are required of the robot, which further increases the damaging possibilities of known robots in the extremely probable collision situations. Moreover, prior art robots are extremely precise, which in practice makes the robots very expensive, particularly when this kind of high degree of precision is not needed in activities like waste sorting. Moreover, known robots are too slow for effective waste sorting, and a possible speed increase results, as a consequence of the conventional heavy structure, in too high torques, which can be disastrous particularly in collision situations.

By means of the solution according to the present invention for moving and positioning a robot gripping unit, there is achieved a rapid and accurate control system of the gripping unit by intermediation of cables, where possible problems connected to collisions of the gripping unit are minimized. The solution is based on a mechanical fastening arrangement used in the fastening of the gripping unit, by which at least one or several of the degrees of freedom of the gripping unit are removed, so that respectively the gripping unit control can be realized by fewer cables and connected servo winches. This mechanical fastening arrangement also offers an advantageous route for conducting and connecting the wires/cables needed while using the gripping unit, such as electric and data cables, or pneumatic or hydraulic tubes, to the gripping unit.

Thus the structurally simplified moving and positioning of a gripping unit according to the invention substantially simplifies the programmable logics applied when controlling the gripping unit, as well as the structure of the whole robot using the gripping unit. This kind of simplified structure makes the arrangement according to the invention particularly durable and light-weight, which means that the speeds applied in its operation can be increased.

In a particularly advantageous solution, the arrangement according to the invention can be applied in robots used for sorting waste. In this case the weight of the objects handled by the robot is typically 0.1-5 kg, but in an arrangement according to the invention, the maximum weight can, when necessary, be raised up to tens or even hundreds of kilos by simple structural adjustments.

In comparison with known cable robots, by using the mechanical fastening of the gripping unit according to the invention, there is easily achieved a circular or curved path for the gripping unit, which is the most problematic motion type to be realized with cables only, and requires long distances between the fastening points of the control cables.

In comparison with known portal robots, i.e. robots controlled by intermediation of control rails, the use of the arrangement according to the invention that is based on cables and mechanical fastening of the gripping unit results in a simpler structure and a remarkably improved collision durability.

Advantageously the mechanical fastening of the gripping unit according to the invention removes three degrees of freedom in moving the gripping unit. An example of said fastening arrangement eliminating three degrees of freedom of the gripping unit is a two-part support arm known for instance from the support structure of table lamps, where each element of the support arm includes two adjacent and parallel arms interconnected at the joints. However, because the support arm can be turned with respect to its fastening point, the motional range of the gripping unit forms a cylindrical coordinate system. A gripping unit fastening arrangement realized with this kind of support arm enables the motion of the gripping unit on an XYZ plane, but it prevents rotary motion at the end of the support arm. Thus, in an arrangement according to this example, all three rotational degrees of freedom of the gripping unit are eliminated.

This kind of arrangement eliminating three degrees of freedom of the gripping units described above can be easily modified to eliminate only one or two degrees of freedom in moving the gripping unit. For example by adding a vertical, hinge-like joint in between the gripping unit and its mechanical support structure, so that the gripping unit can turn with respect to the vertical axis of the hinge, this kind of arrangement removes only two degrees of freedom in moving the gripping unit. Respectively by adding to the system, apart from the first vertical hinge-like joint, a second hinge-like joint that is set for example on the horizontal plane, so that the gripping unit can also turn around the horizontal axis of said second hinge, there is achieved an arrangement where only one degree of freedom in moving the gripping unit is removed.

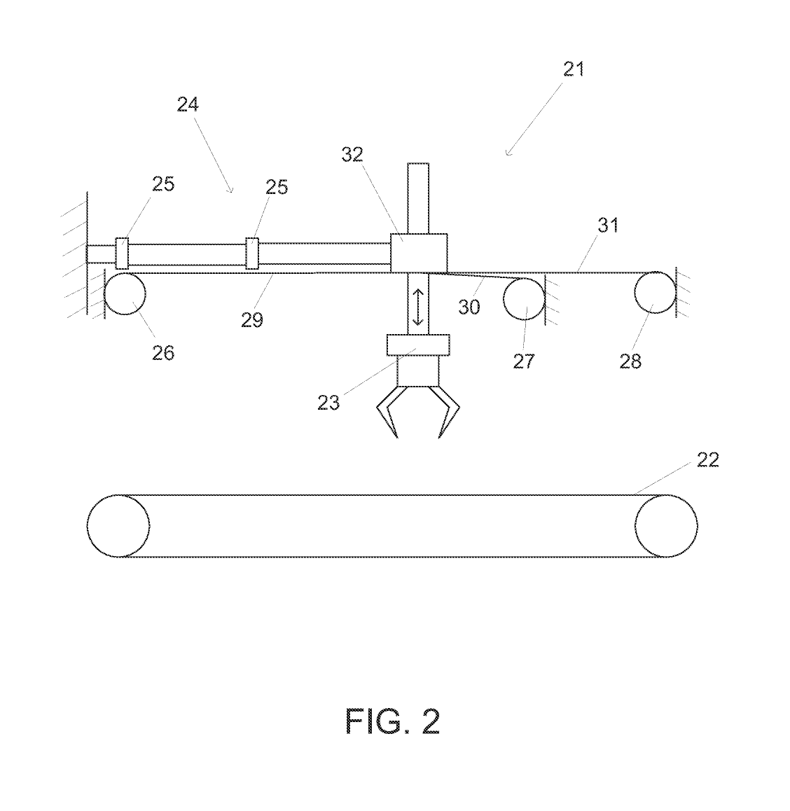

By means of a gripping unit fastening according to the invention, also four degrees of freedom in moving the gripping unit can be removed. This kind of arrangement is described with reference to the embodiment shown in FIG. 2, and in the related description.

Consequently, as is apparent from the above description, in an arrangement according to the present invention, by means of a mechanical fastening of the gripping unit, it is possible to remove one, two, three or four degrees of freedom in moving the gripping unit. However, it is pointed out that in an arrangement according to the invention, the gripping unit is only moved by intermediation of servo winches and connected cables, and possibly by intermediation of gravity.

This kind of reduction or total elimination of the rotational degrees of freedom of the gripping unit enables the use of servo winches with a precision that is smaller than usual when moving the gripping unit. Thus, in an arrangement according to the invention, it is possible to use simpler and more robust servo winches, which in turn makes the arrangement economically more advantageous.

In an arrangement according to the invention, a tensile force is advantageously caused in all cables moving the gripping unit, which improves the conditions of both controlling and monitoring the gripping unit. Said tensile force is brought in the cables for instance by braking elements arranged in connection with the servo winches, or alternatively for instance by logics controlling the servo winches, such as by using torque control in part of the servo winches.

Advantageously the arrangement according to the invention can be realized by four cables moving the gripping unit and by servo winches operating the cables, in which case the servo winches are set in a pattern forming a tetrahedron.

As an alternative, the arrangement according to the invention can be realized so that the gripping unit that is mechanically attached to the support structure is controlled by three servo winches, all three of said servo winches being positioned above the gripping unit. In this case the gripping unit “hangs” from the servo winch cables, and the downwardly oriented motion of the gripping unit is achieved, in addition to the servo winches, by intermediation of gravity.

Preferably the arrangement according to the invention is also provided with means based on computer vision and/or servo winch control for defining the position of the gripping unit. For example, an encoder or other sensor installed in connection with the servo winch can be used for monitoring the position of the servo winch and hence the position of the gripping unit. Commercially available servo motors often include this kind of readable location data as a standard feature. For defining the position of the gripping unit, it is also possible to utilize the position of the joints in the mechanical fastening of the gripping unit, which can be monitored for example by installing in connection therewith an encoder or other corresponding sensor observing the rotation of the joint. When utilizing the mechanical fastening of the gripping unit for defining the gripping unit position, the structure of the servo winches can be simplified, because there is more available data of the gripping unit position, and thus the cable control need not be as precise.

In an arrangement according to the invention, the servo winches are preferably controlled by a computer program. In that case the operation of the computer advantageously comprises the defining of the position of at least one servo winch, said position corresponding to the desired new position of the gripping unit; the guiding of said at least one servo winch to the defined position; and the controlling of other servo winches to maintain the set tensile force in each connected cable.

The arrangement according to the invention can advantageously be used in a robot, particularly in a robot designed for sorting waste.

More precisely, the method according to the invention is characterized by what is set forth in the characterizing part of claim 1, and the apparatus according to the invention is characterized by what is set forth in the characterizing part of claim 8, and the robot according to the invention is characterized by what is set forth in the characterizing part of claim 15.

The invention is described in more detail below, by way of example, with reference to the appended drawings, where

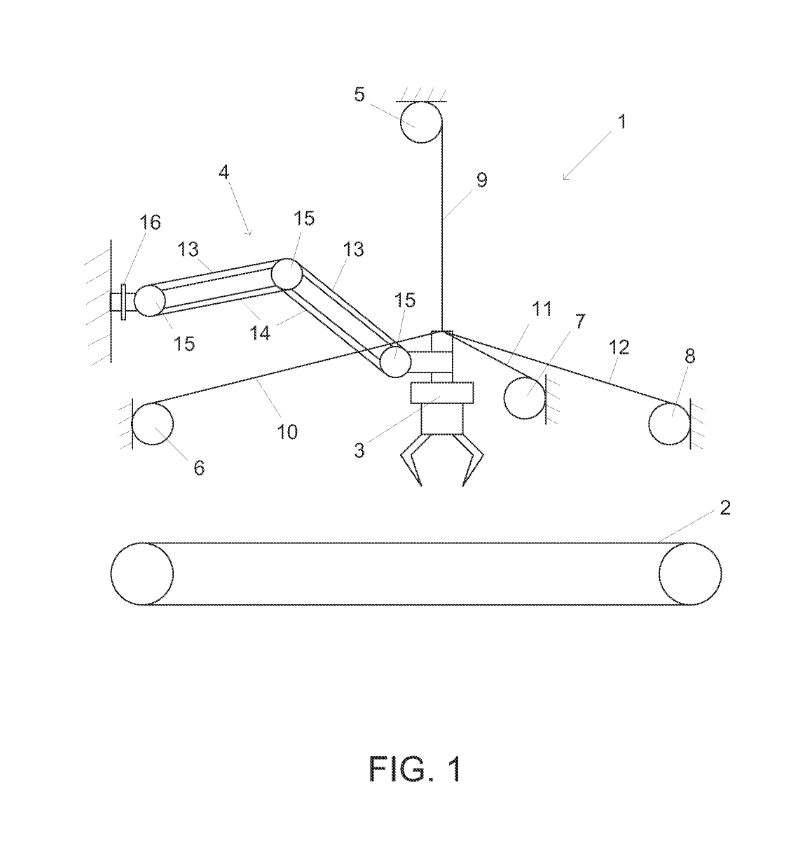

FIG. 1 is a schematical illustration of an arrangement according to the invention, provided with a gripping unit,

FIG. 2 is a schematical illustration of an alternative embodiment of an arrangement according to the invention, provided with a gripping unit, and

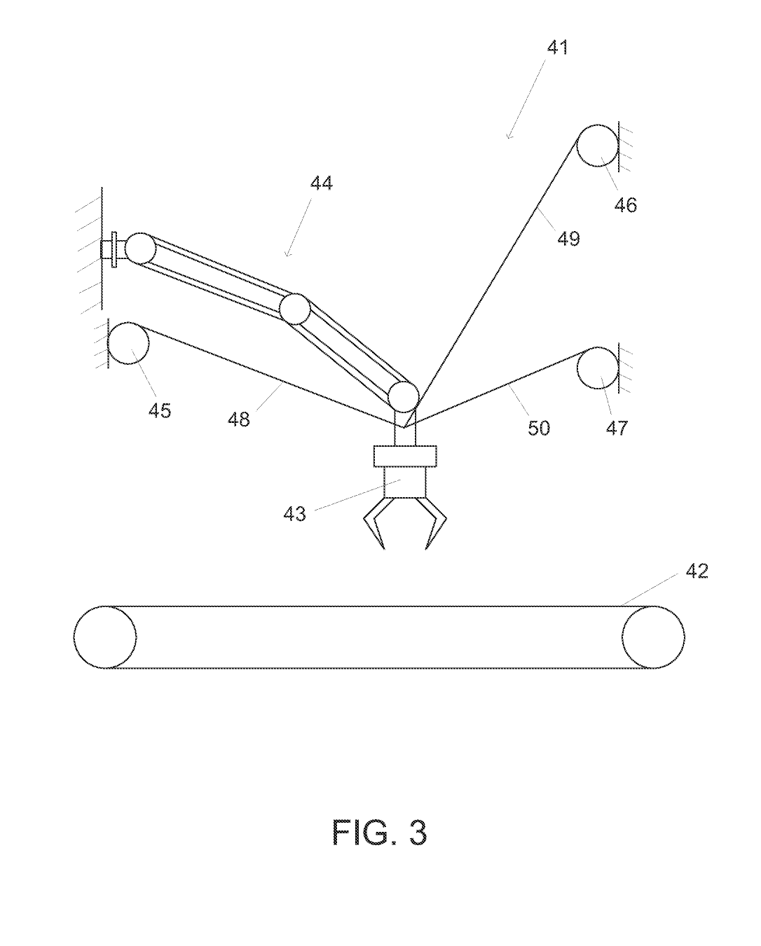

FIG. 3 is a schematical illustration of another alternative embodiment of an arrangement according to the invention, provided with a gripping unit.

The arrangement according to the invention, schematically illustrated in FIG. 1, describes a sorting robot 1 used for handling construction waste, which robot is arranged to work in connection with a conveyor 2 conveying construction waste.

The sorting robot 1 includes a gripping unit 3, a mechanical support arm 4 fastening the gripping unit to the support structure, and four servo winches 5, 6, 7 and 8, which are connected to the gripping unit 3 by intermediation of cables 9, 10, 11 and 12.

The mechanical fastening arm 4 of the gripping unit 3 has two elements, and each of the elements of the fastening arm 4 is formed of two parallel bars or shafts 13 and 14, both of which are articulated through their own pivot joints to the connecting pieces 15. Thus, when moving the gripping unit 3 by intermediation of the servo winches 5, 6 and 7, and by the cables 10, 11 and 12 on the XYZ plane, the gripping unit has no access to perform a rotary motion in relation to the mechanical fastening arm 4. The mechanical fastening arm 4 is attached to the support structure by a hinge 16, which allows the fastening arm to turn with respect to the vertical axis of the hinge, so that the motional range of the gripping unit forms a cylindrical coordinate system. Hence, by using this type of mechanical fastening 4, all three rotary degrees of freedom in moving the gripping unit 3 are removed.

However, here it is pointed out that the gripping unit 3 itself is provided with means for rotating its gripper to a suitable position with respect to the vertical axis of the gripping unit for gripping an object.

When using the sorting robot 1 of FIG. 1, construction waste is brought as a continuous material stream on a conveyor 2 in the robot's operation range. From the conveyor 2, the objects determined to be sorted by the sorting robot 1 are identified, and their position on the conveyor is analyzed by various analyzing means, which can be based for instance on computer vision. Data of these objects is transmitted to the control logics of the robot 1, which control logics control the operation and location of the gripping unit 3 in the working area by intermediation of the servo winches 5, 6, 7 and 8, and by the connected cables 9, 10, 11 and 12.

The position of the gripping unit 3 of the sorting robot 1 can be defined by devices provided in the servo winches 5, 6, 7 and 8, such as microswitches or encoders, or by identification devices based on computer vision, or by combinations of these. Encoders can also be connected to the mechanical fastening arm 4 and to its fastening arrangement for defining the position of the gripping unit 3, or for helping out in this defining process.

In an arrangement according to the invention, the servo winches 5, 6, 7 and 8 of the sorting robot 1 keep the cables 9, 10, 11 and 12 continuously tight, in order to be able to define the position of the gripping unit 3 through the servo winches, and to better control the motion of the gripping unit 3. This tension is created for example by means of programming, so that each servo winch is always defined to pull the cable by a predetermined force, or by means of the structure of the servo winches, in which case the pretensile force of the cables can be produced for example by arrangements based on springs or on the elasticity of the material.

This keeping of the cables 9, 10, 11 and 12 in tension can also be realized so that three of said four servo winches 5, 6, 7 and 8 are controlled by position control, and one of the servo winches is controlled by force control. In other words, three position controlled servo winches define the position of the gripping unit, and the force controlled servo winch keeps all cables tight. In commercially available servo motors, position and force control are common, readily installed features.

In an arrangement according to the invention, as is illustrated in FIG. 1, the servo winches 5, 6, 7 and 8 are mutually positioned so that they form a tetrahedron-shaped pattern, and the servo winches are located at the tips of the tetrahedron. With this kind of pattern, there is achieved best control of the controlled gripping unit, and in addition, the above described servo winch control that is based on position and force control is advantageous in a situation where the acceleration of the load is oriented towards that face of the tetrahedron that has the position controlled servo winches as tips, in which case the position controlled servo winches pull the cable from the torque controlled servo winch.

By utilizing the robot arrangement illustrated in FIG. 1, there is obtained a robust and durable robot that is not sensitive to collisions with the construction waste to be sorted. Suitable operation variables for the gripping unit of an arrangement illustrated in FIG. 1 are for example: maximum acceleration 3 g, maximum speed 4 m/s and precision +/−0.5 cm.

In the alternative embodiment of the invention, illustrated in FIG. 2, the sorting robot 21 arranged to operate above a waste conveyor 22 is provided with a mechanical fastening arm 24, which fastens the gripping unit 23 to the support structure.

The mechanical fastening arm 24 has two elements, so that the fastening of the arm to the support structure, and the mutual fastening of the arm elements, is realized by hinge-like articulations 25, which allow the motion of the arm and its elements only on the horizontal plane. The gripping unit 23 attached at the end of the fastening arm 24 is moved on the horizontal plane by three servo winches 26, 27 and 28 by intermediation of cables 29, 30 and 31. In this case the servo winches 26, 27 and 28 are attached substantially on the same horizontal plane.

The vertical motion of the gripping unit 23 is obtained by a suitable actuator 32 creating linear motion, by intermediation of which the gripping unit is connected to the fastening arm 24. As an alternative, the actuator producing the linear motion can form part of the gripping unit 23.

With the embodiment illustrated in FIG. 2 it is possible to eliminate the servo winch and cables producing the vertical motion, which simplifies the structure and control logics of the arrangement. The mechanical fastening arm 24 according to the embodiment of FIG. 2 removes four degrees of freedom in moving the gripping unit.

In the embodiment illustrated in FIG. 3, the sorting robot 41 arranged to operate above a waste conveyor 42 is provided with a mechanical fastening arm 44, which fastens the gripping unit 23 to the support structure. In structure, the mechanical fastening arm 44 corresponds in all substantial parts to the mechanical fastening arm 4 illustrated in connection with FIG. 1, but it is attached to the support structure on a higher plane than the mechanical fastening arm 4 of FIG. 1.

In this embodiment of FIG. 3, the gripping unit 43 is controlled and positioned by three servo winches 45, 46 and 47, as well as by cables 48, 49 and 50 operated thereby. A remarkable point in the embodiment of FIG. 3 is that all three servo winches 45, 46 and 47 are attached to the support structure on horizontal planes, all of which are located substantially above the horizontal plane of the gripping unit 43, preferably also higher than the upper surface of the working area of the gripping unit 43, or at least substantially on the same level with said upper surface of this working area.

In this embodiment, when shifting the gripping unit 43 downwards, the servo winches 45, 46 and 47 release their cables outwards, so that the gripping unit is shifted downwardly owing to the effect of gravity.

By the positioning of the servo winches 45, 46 and 47 in the pattern according to FIG. 3, the cables 48, 49 and 50 of the servo winches are shifted away from the working area of the gripping unit 43, so that they do not get into contact with the waste material to be sorted.

Although the invention is described above with reference to the examples and embodiments illustrated in the drawings only, the arrangement according to the invention is not restricted to said solutions. Alternative embodiments and their modifications are possible in ways obvious for a person skilled in the art, within the scope defined by the appended claims.

1. A method for moving and positioning a gripping unit (3; 23; 43), in which method the gripping unit is moved and positioned by intermediation of cables (9, 10, 11, 12; 29, 30, 31; 48, 49, 50) attached to the support structure, characterized in that at least one degree of freedom of the gripping unit (3; 23; 43) is removed by fastening the gripping unit mechanically to the support structure by intermediation of an arm (4; 24; 44).

2. A method according to claim 1, characterized in that by a mechanical fastening (4; 24; 44) of the gripping unit (3; 23; 43), there are removed two, three or four degrees of freedom in moving the gripping unit.

3. A method according to claim 1, characterized in that the gripping unit (3; 23; 43) is moved and positioned by changing the length of at least one cable (9, 10, 11, 12; 29, 30, 31; 48, 49, 50) and by simultaneously maintaining the tensile force in the rest of the cables.

4. A method according to claim 3, characterized in that the number of the cables (9, 10, 11, 12) moving the gripping unit (3) is four, and each of the cables is operated by intermediation of a servo winch (5, 6, 7, 8), said servo winches being positioned in a pattern forming a tetrahedron.

5. A method according to claim 3, characterized in that the number of the cables (48, 49, 50) moving the gripping unit (43) is three, and each of the cables is operated by intermediation of a servo winch (45, 46, 47), each of said servo winches being positioned on a horizontal plane, each of said horizontal planes being located above the horizontal plane of the gripping unit.

6. A method according to claim 4, characterized in that in the method:
there is defined a new position for at least one servo winch (5, 6, 7, 8; 26, 27, 28; 45, 46, 47), said new position corresponding to the desired new position of the gripping unit (3; 23; 43),
said at least one servo winch is guided in the defined position, and
the rest of the servo winches are set to maintain a predetermined tensile force in each cable (9, 10, 11, 12; 29, 30, 31; 48, 49, 50).

7. A method according to claim 1, characterized in that the moving and positioning of the gripping unit (3; 23; 43) is realized by a computer program.

8. An apparatus for moving and positioning a gripping unit, said apparatus comprising a gripping unit (3; 23; 43), cables (9, 10, 11, 12; 29, 30, 31; 48, 49, 50) connected to a support structure for moving and positioning the gripping unit, and for each cable an operating servo winch (5, 6, 7, 8; 26, 27, 28; 45, 46, 47), characterized in that the apparatus includes mechanical fastening of the gripping unit (3; 23; 43) to a support structure by intermediation of an arm (4; 24; 44) for removing at least one degree of freedom of the gripping unit.

9. An apparatus according to claim 8, characterized in that the mechanical fastening (4; 24; 44) of the gripping unit (3; 23; 43) is formed to remove two, three or four degrees of freedom in moving the gripping unit.

10. An apparatus according to claim 8, characterized in that the apparatus includes means and/or program means arranged in connection with the servo winches (5, 6, 7, 8; 26, 27, 28; 45, 46, 47) operating each cable (9, 10, 11, 12; 29, 30, 31; 48, 49, 50) for producing tensile force in each cable.

11. An arrangement according to claim 10, characterized in that the arrangement comprises four cables (9, 10, 11, 12) with respective servo winches (5, 6, 7, 8) for moving and positioning the gripping unit (3), said four servo winches being positioned in a pattern forming a tetrahedron.

12. An apparatus according to claim 11, characterized in that the apparatus comprises three cables (48, 49, 50) with respective servo winches (45, 46, 47) for moving and positioning the gripping unit (43), all three of said servo winches being located on horizontal planes, each of said horizontal planes being located above the horizontal plane of the gripping unit.

13. An apparatus according to claim 8, characterized in that the apparatus includes a computer program for controlling the servo winches (5, 6, 7, 8;
26, 27, 28; 45, 46, 47).

14. An apparatus according to claim 11, characterized in that the apparatus includes means, based on computer vision and/or connected to servo winches (5, 6, 7, 8; 26, 27, 28; 45, 46, 47), and/or connected to articulations (15; 25) of mechanical fastening (4; 24; 44) for defining the position of the gripping unit (3; 23; 43).

15. A robot (1; 21; 41), particularly a robot designed for handling waste, characterized in that it includes an apparatus according to claim 8.

16. A method according to claim 2, characterized in that the gripping unit (3; 23; 43) is moved and positioned by changing the length of at least one cable (9, 10, 11, 12; 29, 30, 31; 48, 49, 50) and by simultaneously maintaining the tensile force in the rest of the cables.

17. A method according to claim 5, characterized in that in the method:
there is defined a new position for at least one servo winch (5, 6, 7, 8; 26, 27, 28; 45, 46, 47), said new position corresponding to the desired new position of the gripping unit (3; 23; 43),
said at least one servo winch is guided in the defined position, and
the rest of the servo winches are set to maintain a predetermined tensile force in each cable (9, 10, 11, 12; 29, 30, 31; 48, 49, 50).

18. An apparatus according to claim 9, characterized in that the apparatus includes means and/or program means arranged in connection with the servo winches (5, 6, 7, 8; 26, 27, 28; 45, 46, 47) operating each cable (9, 10, 11, 12; 29, 30, 31; 48, 49, 50) for producing tensile force in each cable.
